(19) United States
(12) Patent Application Publication
(10) Pub. No.: US 2015/0332359 A1
(43) Pub. Date: Nov. 19, 2015

(54) METHOD FOR PURCHASING AND TAKING DELIVERY OF ENERGY PRODUCTS BY END USER THROUGH WHOLESALE MARKETS DISPENSER

(71) Applicant: Terrence C. Ayala, Miami, FL (US)

(72) Inventor: Terrence C. Ayala, Miami, FL (US)

(21) Appl. No.: 14/807,979

(22) Filed: Jul. 24, 2015

Related U.S. Application Data
(62) Division of application No. 13/632,176, filed on Oct. 1, 2012.

(51) Int. Cl. G06Q 30/06

(52) U.S. Cl. CPC G06Q 30/0607

(57) ABSTRACT

A business method through which end users can purchase automobile fuel and/or energy products on-line. It accomplishes this using a Marketing, Accounting, and Distribution System which unbundles the various components of a traditional gasoline purchase transaction. One of the system's many benefits is that it allows an end user (meaning a consumer or organization consisting of many consumers) to separate the energy purchase decision from the time and place where that end user takes delivery, thereby increasing the end user's choices and flexibility. This is because the present invention allows an end user to purchase energy products and arrange for subsequent at a station of the end user's choosing.

### CROSS REFERENCE TO RELATED APPLICATIONS

This application is a divisional application of U.S. patent application Ser. No. 13/632,176, filed Oct. 1, 2012, which claimed the benefit of U.S. provisional patent application Ser. No. 61/541,156, filed Sep. 30, 2011.

### BACKGROUND OF THE INVENTION

1. Field of the Invention

This invention relates generally to a method to purchase and take delivery of energy products, and more specifically to a platform through which an end user can engage in purchasing gasoline (or electricity) through commodity markets with the option to take delivery through standard dispensing arrangements.

2. Description of Related Art

The existing paradigm for the purchase and delivery of automotive fuel is well known in the art. This existing paradigm exists under the basic assumption that end users of automotive fuel must purchase and take delivery of automotive fuel simultaneously and at the same location, or in other words, “pay at the pump.” At the time this paradigm was organized, it is possible that the prevailing technology provided no reasonable alternative to a requirement that all end users must “pay at the pump.”

As such, a complex system developed to facilitate the provision of automotive fuel for consumption through a plurality of dispensing stations accessible by end users. Such is reflected when the traditional retail price of gasoline at a gas station is analyzed in its parts. When an end user completes a traditional gas purchase at a gas station, the end user is actually paying for the following: (1) a commodity price for gas, reflecting the cost of extraction and refinement, (2) a fee for transporting the gas from the refinery to a local terminal, (3) a fee for distributing the gas from the local terminal to a dispensing service station, (4) a fee to cover the dispensing service station's operating costs, (5) a fee to cover the branding and marketing of the gas, and (6) taxes and inspection fees collected by local, state and federal governments. In addition to the foregoing, the price paid by the end user may reflect regulated charges, credits, discounts and rebates which apply at various stages in the gas supply chain. Likewise, the transaction might also include fees and rebates associated with a credit card provider.

Thus, the existing paradigm's cost recovery system must account for: (1) the extraction of crude oil from the ground, (2) the transport of said crude oil to refineries, (3) the storage of gasoline refined from said crude oil at the refineries, (4) the transport of the refined gasoline bulk storage terminals through pipeline facilities, tankers, or barges, (5) the storage of the gasoline at bulk storage terminals, (6) the transport of said gasoline to dispensing stations (or “gas stations”) in tanker trucks, and (7) the storage, sale and dispensing of the gasoline at gas stations. Despite subsequent advances in certain manners of wholesale transactions, fuel supply methods, and information technology, this complex system has prevailed largely unchanged to this day.

Today, however, wholesale fuel transactions and fuel supply methods reflect that commodity brokers have a broad range of sourcing options. Those options have expanded greatly since the existing automotive fueling paradigm was organized. Now, fuel distribution/marketing networks recognize that a wholesaler can “introduce” a quantity of a “fungible commodity” such as gasoline at one location in the supply chain. That wholesaler can then exchange its right to that commodity for the right to extract that quantity from multiple locations connected to the supply chain.

Advances in information technology tools also potentially present avenues through which the existing paradigm for the purchase and delivery of automotive fuel can be altered or abandoned. U.S. Pat. No. 7,840,446, issued Nov. 23, 2010, shows a stored value transaction system including an integrated database server. That computer based system utilizes database server which supports a number of stored value products, each of which correspond to financial products offered to customers by financial institutions. This allows end users to interact with the server in order to redeem said stored value.

There is therefore a need for a system and method that accounts for the improvements made and efficiencies introduced in the wholesale transaction, fuel supply, and information technology aspects of the sale and delivery of automotive fuel products to end users.

The present invention meets these needs and removes the assumed requirement that automotive users must “pay at the pump” by creating an on-line exchange and reservation network which will allow participants in an automotive fuel (or any other commodity) acquisition and distribution process to conduct their transactions more efficiently and transparently. In addition, the system monitors changes in conditions and circumstances at the facilities where the commodity is processed, stored or transported, and provides real-time reports of such changes to the system's Administrators.

### SUMMARY OF THE INVENTION

A business method comprising a software program on a computer system and a network of participants through which “end users” can purchase automobile fuel and energy products on-line. It accomplishes this using a Marketing, Accounting, and Distribution System (“System”) which unbundles the various components of a traditional gasoline purchase transaction. One of the System's many benefits is that it allows an “end user” (meaning a consumer or organization consisting of many consumers) to separate the energy purchase decision from the time and place where that end user takes delivery, thereby increasing the end user's choices and flexibility. This is because the present invention allows an end user to purchase energy products at locations other than the stations at which he or she takes delivery of that product.

Moreover, this method will allow an end user to maintain an “inventory” of gasoline, and add to or withdraw from that inventory at will without regard to the limits of his or her vehicle's fuel tank. Indeed, the End User will be able to make actual or physical withdrawals of the user's gasoline inventory from a network of gasoline storage providers.

A key component of the System is that it separates the “commodity price” component of an energy acquisition transaction from those components associated with the transportation, storage, distribution, and dispensing. Thus, instead of paying a price, “X” for a gallon of gas at a traditional gasoline station, the end user will pay: (1) a commodity seller an amount, C, for the each gallon of gasoline, (2) a system administration fee, A, for coordinating transportation, distribution, and storage, as well as for maintaining System accounting and ensuring that the commodity will be readily and efficiently available where and when the end user wishes to take delivery, and (3) the service station operator at which the end user takes delivery a fee, S, for serving as a point of storage and dispensing.

Also, by separating the End User's purchasing decision from those regarding the delivery and dispensing, the System will function in a manner which allows End Users to pool their purchasing power. This will allow End Users to pay “fleet” prices for gasoline, rather than pay the usually marked up retail price charged at individual gasoline service stations. Moreover, End Users will be able to make gasoline purchase decisions at a time and place other than at the pump. Thus, End Users will be able to avoid the problem of paying a retail price of $3.50 for gas and then pass another station where the same grade of gas has a posted retail price of $3.25.

An object of this invention is to utilize a computer system to enhance a commodity distribution system's efficiency by providing a processing means: (1) for receiving and fulfilling multiple orders and reservations from multiple End Users for various grades and quantities of a commodity, and allowing those End Users to specify a variety of times and locations for delivery, (2) to aggregate and sort various End Users' orders into homogeneous lots of sufficient quantity and definition to correspond to quantities and qualities which are traded on a national or international commodity exchange, (3) for maintaining a System of reservations for End Users and Providers so as to minimize System congestion and to maximize System throughput and System utilization, (4) for monitoring the status and costs associated with operating the various facilities involved in a functionally and geographical diverse network which features facilities for commodity refinement, transportation, distribution and consumption, and (5) for balancing inventories in a commodity production, refinement, distribution and consumption network so as to maximize the efficient use of System facilities.

It is another object of this invention to enhance such a System's transactional fairness and accessibility by providing: (1) a method for End Users to make decisions about commodity purchases at a time and place which may differ from the time and place where the commodity is ultimately consumed, (2) a method for aggregating End Users' commodity purchases so as to allow End Users to participate in various contracts at wholesale, and (3) a method for facilitating and monitoring changes in ownership of fractional shares of a bulk-purchased commodity between the time of the original acquisition of that commodity and the time when transaction participants take physical delivery of the commodity.

Another objective of this invention is to accommodate complex accounting, financial, legal and regulatory constraints by providing: (1) a method for managing the financial aspects of a System for receiving and fulfilling orders for the delivery of a commodity which has a highly volatile price or value, (2) a method for a wholesale commodity transaction to be decomposed efficiently and economically and in a manner which allows persons who participate in the transaction to engage in post-acquisition trades of fractional shares of that commodity prior to taking physical delivery of the commodity, (3) a method for confirming that trades in fractional shares of a commodity purchase conform to the requirements of federal, state, and local laws in the jurisdictions where the transactions are deemed to have occurred, (4) a method to account for various quantities and volumes of a commodity which are introduced into a distribution System or withdrawn from that distribution System, and (5) a method for managing and allocating credits, rebates and discounts.

It is yet another object of the present invention to provide a method for making underlying transactions and planning transparent from the perspective of the End User.

Another object of the present invention is to provide a method for making transactions secure and confidential.

It is another object of this invention to provide a method for facilitating any End User's projections of that End User's future commodity needs.

These and other objects will be apparent to one of skill in the art.

### BRIEF DESCRIPTION OF THE DRAWINGS

FIG. 1 shows an entity communication diagram for the parties affected by the present invention.

FIG. 2 shows a general process flow chart of a traditional gasoline production model.

FIG. 3 shows a price breakdown diagram of a traditional gasoline price model.

FIG. 4 is a receipt and processing of end user requests flow chart for a System built in accordance with the present invention.

FIG. 5 is processing of reservation requests with all parameters specified flow chart for a System built in accordance with the present invention.

FIG. 6 is an order fulfillment process flow chart for a System built in accordance with the present invention.

FIG. 7 is a delivery and settlement process for a System operated dispensing station flow chart for a System built in accordance with the present invention.

FIG. 8A shows a partial view of an alternate embodiment of a delivery and settlement process for a non-System operated dispensing station flow chart for a System built in accordance with the present invention.

FIG. 8B shows a partial view of an alternate embodiment of a delivery and settlement process for a non-System operated dispensing station flow chart for a System built in accordance with the present invention.

FIG. 9 shows an order pooling and allocation diagram for a System built in accordance with the present invention.

FIG. 10 shows a purpose overview flow chart for a System built in accordance with the present invention.

### PREFERRED EMBODIMENT OF THE INVENTION

In April 1985, the Federal Energy Regulatory Commission (“FERC”) adopted its Order No. 436, thereby establishing a voluntary “open access” transportation program for natural gas markets. A key aspect of that program was that natural gas market participants were able to “unbundle” energy costs, meaning they were able to separate the cost of producing and processing natural gas from the costs associated with transporting that gas from the point of production to the point of consumption. Thus, the open-access program allowed natural gas pipeline operators to offer transportation services not linked to gas commodity sales service. That program also allowed utilities and large volume energy customers to purchase natural gas directly from producers and/or marketing companies. In turn, those customers paid pipeline operators separately to transport the commodity to the point of consumption.¹ See)://www.pmel.org/NaturalGas Gloss y.htm#436; see also http://www.energychoices.us/natural_gas.html.

The present invention extends that “unbundling” process to the refined petroleum markets. To that end, the System takes advantage of computers and the Internet so as to manage the various parts of a gasoline purchase and distribution transaction. It does so in order to combine many End Users' purchase and distribution transactions so as to create beneficial economies of scale.

At the same time, the System recognizes that, throughout the United States and elsewhere, governments have enacted or imposed statutes and regulations to manage the sale and distribution of gasoline. Thus, the System accommodates a heterogeneous fabric of laws which were designed to protect consumers and to reduce anti-competitive marketing arrangements. Indeed, by unbundling gas purchase, distribution and dispensing transactions, the System liberates those transactions from some aspects of the existing regulatory scheme, but implicates others to which such transactions were previously immune.

For example, the various state and federal governments rely heavily upon tax revenues which gas sales generate; therefore, the method contemplates intrastate and interstate transactions which implicate a mélange of tax laws. The System recognizes that the End User may be deemed liable for a tax on the gas commodity in one state, even though the consumer may actually take delivery of that commodity in another. Likewise, the System recognizes that some but not all states have adopted provisions which outlaw “below-cost” sales (affecting gasoline and other commodities). The System takes such provisions into account and manages each End User's transaction so as to minimize the regulatory impact on cost.

Moreover, gasoline commodity sales contracts are the subject of terms and conditions established by self regulated financial exchanges such as the New York Mercantile Exchange and Chicago Board of Trade Likewise, the method assumes that End Users will ultimately use on line credit accounts and/or electronic funds transfers to pay for the commodities they purchase and services they require. Consequently, we have designed and are implementing the method under review to accommodate a complex collection of state and federal laws, as well as financial, institutional, and industrial arrangements.

The key to the present invention is that it alters a basic assumption upon which the prevailing automotive fueling paradigm is based. More particularly, it challenges the assumption that gasoline consumers must “pay at the pump.” That paradigm gives fuel providers a heightened degree of control over the pricing options that consumers face. Likewise, it limits a consumer's purchasing decisions to the options available at the times and places where he or she can take delivery of fuel. Moreover, the existing paradigm maintains an artificial barrier to transactions that can now be facilitated using the enhanced information the Internet provides.

The present invention recognizes that certain transactional, information technological, and fuel supply advances make it feasible for consumers to access fuel markets using the same techniques which are available to wholesalers. The only differences (between wholesalers and consumers) which are relevant relate to questions of scale. And, when consumers' purchasing decisions are pooled, they can eliminate the scale advantage that wholesalers now exploit.

The method under review employs social networking tools to that end. In the process, the method alters the now-outmoded automotive fueling paradigm. Our method allows consumers to plan for and conduct their fueling purchases well in advance of the moment when the “E” light begins to flash on their cars' dashboards. Now, consumers can track movements in fuel prices on various commodity exchanges. When a price matches a consumer's expectations, that consumer can place an order using our System. In turn, our System bundles that consumer's order with those placed by the System's other customers. The System then executes these bundled orders by purchasing fuels from local, regional or national providers, depending upon the number of consumers participating and other market conditions.

Once the System obtains fuel to “energize” a consumer's order, the System then processes the order so as to allow that consumer to take delivery of his or her fuel at a convenient time and location. The process the System employs will depend upon several variables. One set of variables is determined by the time frame the consumer specifies within which he will take delivery after placing the order. Another set of variables will be determined by the location where the consumer specifies she is likely to take delivery. Yet another set of variables is determined by (a) the number of System controlled or otherwise participating fuel dispensing stations the System has established in the consumer's delivery area; or (b) the type of relationships the System has established with “non-System” fuel dispensing station operators within that area.

The System makes it feasible for End Users to combine their purchasing power so as to take advantage of opportunities to purchase gas (and related services) at wholesale prices at local, regional or nation markets. For instance, 42,000 gallons is the standard volume for a “New York Harbor RBOB Gasoline (Physical) futures . . . gasoline contract between a buyer and a seller” on the New York Mercantile Exchange.² If we assume that the typical End User takes delivery of 15 gallons at a time, then the System would need to bundle together 2800 End User Reservation Requests (“EURRs”) to support one order on the NYMEX. ²See NYMEX Rulebook, Chap. 191, Sec. 191.02, published at http://www.cmegroup.com/rulebook/NYMEX/1a/191.pdf.

So long as individual End Users purchase gas in the traditional manner, their transactions will be of insufficient size to take advantage of the wholesale markets. However, the System restructures the traditional marketing arrangement so that End Users gain the ability to join together more efficiently. Thus, the System's basic function will be to take multiple End Users' reservations for pre-purchased quantities of gas and to make arrangements for such users to take delivery at times and places the End Users will specify. The System will then aggregate such reservations to build a contract to purchase gas on an exchange such as the NYMEX.

Still, the ability to participate in a wholesale commodity purchase will be of little practical value unless an End User has a mechanism for taking delivery of his share of the contracted volume. To that end, the System will offer End Users various alternatives. So, when the End User registers a reservation with the System, it may create a corresponding reservation which resembles one of the following scenarios:

| | Scenario | Scenario | Scenario | Scenario |
|---|---|---|---|---|
| Parameter | 1 | 2 | 3 | 4 |
| Type of | 87 Octane | 87 Octane | 87 Octane | 87 Octane |
| Gasoline | | | | |
| Quantity | 10 | 40 | 1000 | 20 |
| (gals.) | | | | |
| Brand | Shell | Unspecified | Unspecified | Unspecified |
| State | Florida | Florida | Florida | Unspecified |
| County | Broward | Broward or | Broward | Unspecified |
| | | Miami-Dade | | |
| Dispensing | Pine Island & | Unspecified | Unspecified | Unspecified |
| Station | Broward | | | |
| Pump | 6 | Unspecified | Unspecified | Unspecified |
| Week of | 2011/17 | 2011/18 to | Unspecified | 2011/17 |
| Delivery | | 2011/22 | | |
| Day of | Tuesday | Unspecified | Unspecified | Tuesday |
| Delivery | | | | |
| Hour of | 1500 | Unspecified | Unspecified | 1500 |
| Delivery | | | | |

These scenarios reflect the broad range and flexibility the System is designed to accommodate. Scenario 1 may resemble the traditional retail purchase transaction most closely. In this scenario, as she prepares her on-line reservation, the End Users specify all of the parameters for her gas purchase transaction. When the System accepts her reservation, it makes prepaid arrangements for the commodity component as well as the distribution, dispensing, tax and other components. Depending upon System loads, the End User may enjoy additional savings for specifying all parameters at the time of her order. Alternatively, if the EU has specified parameters that coincide with taking delivery during a peak demand period, then the System may require that EU pay a premium. In any event, under Scenario 1, after the System has accepted the EU's reservation, the System will collect the applicable taxes and fees from the EU, and the EU may proceed to the designated dispensing station and take delivery.³ In anticipation, the System will make arrangements with the Dispensing Station to ensure that the EU's pre-purchased quantity is available as specified. That means that the System will pay the Distribution Component to the Jobber who supplies the DS. Likewise, after the End User takes delivery, the System will pay the DS for that service.⁴ ³The System will also accommodate the circumstance where the EU cannot take delivery at the time and location she originally specified in her reservation.⁴As a practical matter, rather than make specific payments associated with individual deliveries at the time it accepts an EU's reservation, with regard to Jobbers, Dispensing Stations and/or Energy Product Wholesalers, the System will employ Fulfillment and Settlement Modules. These modules will balance the System's Inventory and Accounting obligations at efficient intervals.

While Scenario 1 closely resembles the traditional gas purchase transaction, an End User who wishes to take advantage of the System's flexibility may make arrangements resembling Scenario 2. Under this scenario, the End User merely purchases the right to withdraw 100 gallons of gas from any System Dispensing Station in Broward or Miami-Dade County during Week 17 in 2011. An End User might make such a reservation if he anticipates that during the month of May 2011, he will need to fill his car's tank in one county, and his son's tank in another. Because he is not certain when and where it will be convenient to take delivery, the End User crafts his reservation so as to retain the flexibility to take those deliveries at any station (regardless of brand). Later, the End User can log into the System and specify the remaining parameters. Alternatively, during May 2011, the End User or his son can drive to any System DS and take delivery. Should the month end before the End User can take delivery of all the gas he has purchased, the System will reflect that he retains a credit to withdraw the remaining volume from any DS in Broward or Miami-Dade County. However, the EU will forfeit any discounts he might have received as a result of specifying the temporal parameters when he originally made his reservation.

Whether an End User opts to make a reservation resembling Scenario 1 or Scenario 2, the System will process the resulting reservation by combining it with other EUs' order. Under Scenario 2, the System may accept the End User's reservation and bundle his request for 100 gallons with that of other End Users who have specified that they wish to take delivery of 87 Octane gas in South Florida during week 17. Assuming that End User's have specified a sufficient volume to complete a commodity purchase transaction, the System will then place an order for a contract with a Broker at the NYMEX.⁵ After the Broker notifies the System that it has arranged the RBOB futures contract, the System allocates the gallons within that contract to participating EUs' accounts. ⁵Even if the volume of gallons EUs has reserved is smaller than the NYMEX's minimum contract, the System may opt to proceed with a contract and allocate the remaining volume to its own account.

The scenarios described above illustrate how an End User might engage the System. In addition, the scenarios hint at some of the processes through which the System breaks the traditional retail gas purchase into its separate parts. Again, when we complete a traditional gas purchase, we are actually paying for the following: (1) a commodity price for gas, including the cost of extraction and refinement, (2) a fee for transporting the gas from the refinery to a local terminal, (3) a fee for distributing the gas from the local terminal to a dispensing service station, (4) a fee to cover the dispensing service station's operating costs, (5) a fee to cover the branding and marketing of the gas, and (6) taxes and inspection fees collected by local, state and federal governments.

In addition to the foregoing, the price we pay at the pump may reflect credits, discounts and rebates which apply at various stages in the gas supply chain. Likewise, the transaction might also include fees and rebates associated with a credit card provider.

As it handles the End Users' reservation and/or delivery transactions, the System must account for such fees and costs, albeit at wholesale rather than retail levels. That accounting becomes somewhat more complicated when the EU retains the flexibility to specify the location parameters after making his reservation. In that instance, the System will only be able to determine the taxes which apply after System has identified the DS at which the EU has taken or will take delivery. Thus, when an EU makes his reservation, the System may provide an estimate of the taxes that the EU is likely to be charged, but that estimate will be subject to a final settlement.

Likewise, until such time as the EU takes final delivery, the EU's charges for transportation, distribution and dispensing may remain undetermined. The EU may have specified the county in which he or she expects to take delivery. On that basis, the System may be able to provide firm estimates concerning the final transportation and distribution charges associated with a reservation. Nevertheless, until the EU actually takes delivery, the actual costs associated with the non-commodity components of the transaction will remain undetermined.

In addition, the System will need to maintain reserves with operators of a variety of branded dispensing stations. These reserves will allow End Users to have the flexibility to take delivery of gas at unspecified locations on the fly. Therefore, when an EU takes delivery of 15 gallons at a Mobil station, the System can direct the DS operator to debit the System's account for the gas the EU has received. In turn, the System will adjust the EU's account to reflect that the EU has used his right to withdraw 15 gallons from the System. Similarly, the System will make adjustments to cover the remaining cost components associated with the EU's purchase and delivery.

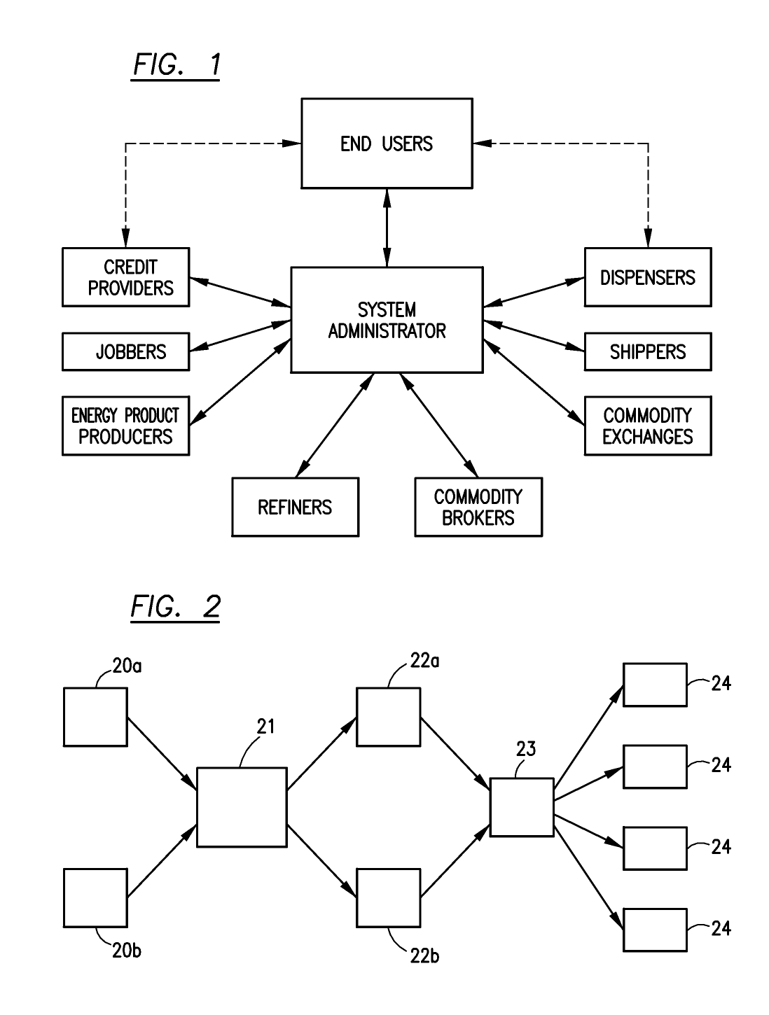

Referring now to the drawings and in particular FIG. 1, the System Administrator (“Administrator”) is at the center of all interaction in the business method under consideration. The Administrator is responsible for receiving and fulfilling orders placed and reservations made by the End Users. The Administrator will do so by completing commodity purchases employing the services of commodity brokers, by reserving System resources to allow the purchased commodity to be stored, transported, distributed and dispensed, and by maintaining records and accounts reflecting these processes. Likewise, the Administrator maintains an exchange which allows End Users to trade their fractional interests in previously ordered commodities and/or reserved services. To these ends, the Administrator maintains relationships with: (A) Brokers, who conduct transactions on the Administrator's behalf at Commodity Exchanges such as the NYMEX or Chicago Board of Trade, (B) Petroleum Refiners⁶, (C) Petroleum Transporters and Carriers, such as Colonial Pipeline, Buckeye Partners, L.P. and Citgo Petroleum Corporation, (D) Local Terminal Facilities, (E) Local Distributers/Jobbers, (F) Local Dispensing Stations (Service Stations), and (G) End Users. ⁶See http://www.eia.doe.gov/neic/rankings/refineries.htm

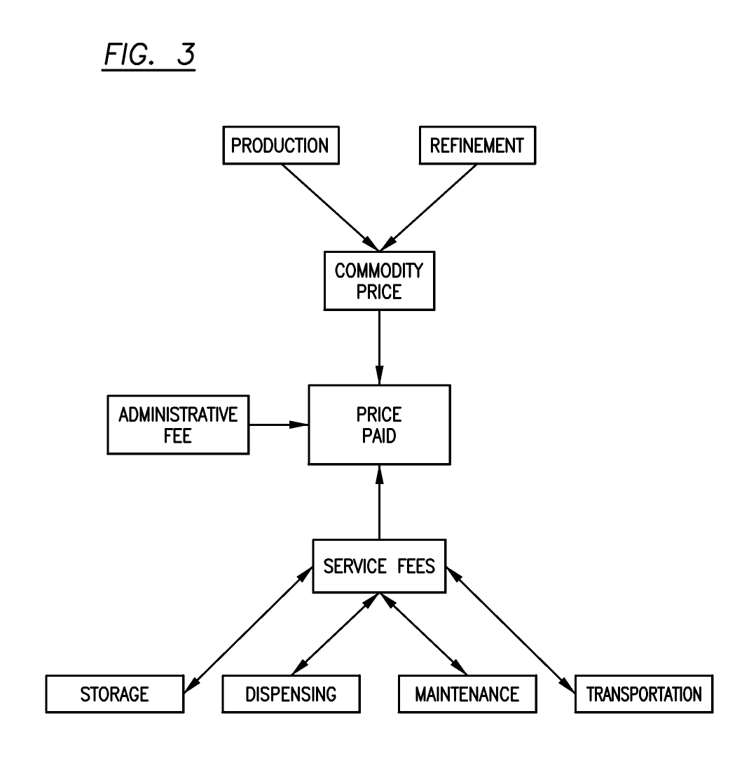

Referring now to FIG. 2, the steps at present time through which crude oil is refined into refined gasoline and transported to stations to be dispensed to End Users are shown. Generally, the process begins with the importation of imported crude oil 20a or the extraction of domestic crude oil 20b (collectively “20”). Next the crude oil 20 is sent to a refinery 21 where it is refined. The refined fuel is then transported to either a pipeline storage facility 22a or kept at a refinery storage facility 22b. From pipeline storage facility 22a, the fuel can be piped to a bulk storage terminal 23. From a refinery storage facility 22b, the fuel is typically sent by tanker or barge to the bulk storage facility 23. From the bulk storage facility 23 tanker trucks typically deliver the fuel to fuel to a plurality of fueling stations 24. The fueling stations 24 are where the user typically is able to pay for and take delivery of fuel at the time it is necessary or desired.

The present invention operates within the existing confines of these general steps, but works to offer End Users the ability to pool their purchases in order to purchase fuel at the commodity price and pay separately for the other components associated with the production, refinement, transportation, storage, and dispensing that comprise the price of gasoline under the existing pay at the pump system.

The core of the System includes and utilizes the following components:
A. A computer based System (having various components similar to those claimed in the Stored Value System), including:
   1. Data structures; various.
   2. Computational Facilities; various.
      a. Clients, stationary and mobile.
      b. Servers.
      c. Processors.
   3. Communication Devices; various.
   4. Databases and Data Storage.
   5. User Interface Devices.
      a. Data Entry Devices; various.
      b. Data Display Devices; various.
   6. Financial products.

The System interacts with and makes use of the components of the overall traditional automotive fueling set up. Such interaction includes and/or makes use of:
A. Commodities, such as gasoline.
B. Communication Interfaces; various.
   1. Mobile handsets communicating with cellular telephone networks.
   2. Point of Sale Terminals.
C. Physical Status Monitoring Devices
   1. The System includes devices which monitor:
      a. Location of moving tanks.
         (1) Shipping tanks.
         (2) Jobber tankers.
         (3) End User vehicle tanks.
      b. Quantities.
         (1) Oilfield Production.
         (2) Shipping tank levels.
         (3) Refinery Output.
         (4) Pipeline Levels.
         (5) Tank Farm tank levels.
         (6) Jobber tanker levels.
         (7) Dispensing station tank levels.
         (8) End User tank levels.
      c. Queuing order and wait times.
         (1) Shipping tanks; loading and unloading.
         (2) Jobber tankers; loading and unloading.
         (3) End User vehicle; at dispensing stations.
      d. Temperatures; various.
      e. Barometric Pressure; various.
D. Commodity Processing Facilities.
   1. Refineries
E. Commodity Terminal / Storage Facilities
   1. Storage Terminals and Tanks.
   2. Fueling Racks.
   3. Pipelines.
F. Commodity Distribution Facilities and Facilitators. Generally, in Florida and elsewhere, persons who supply or store gasoline must have a license. These licensees include:
   1. Pipelines.
   2. Terminal Operators.
   3. Railroads.
   4. Tanker Ships and Barges.
   5. Jobbers.
G. End User Order Processing Facilities
   1. Desktops.
   2. Mobile Telephone Headsets.
   3. Laptop/Notebook/Tablet Computers.
   4. On-board Vehicle Communication Devices (which monitor the vehicle's fuel tank level).
H. Commodity Dispensing Facilities (Service Stations).
   1. Real Estate.
   2. Storage Tanks.
   3. Fuel Dispensing Terminals.
   4. Communication Interface.

The End User exchanges System credits for delivery of Gas. The End User will use the System for three main purposes, namely to (a) acquire the right to take delivery of gas, (b) locate nearby or otherwise convenient DSS's at which the EU may take delivery of Gas, and (c) exchange System credits for delivery of Gas. Incidentally, the EU will also be able to conduct other transactions or gather additional information, including but not limited to the following: (d) create and maintain an EU account, (e) check Gas Commodity prices, (f) check the status of EU and DSS inventories, (g) check servicing times at DSS's, (h) compare System prices with retail pricing, (i) plan future purchases and deliveries outside, and (j) trade inventories with and/or transfer gas to other System members. The steps the System will use to complete these processes are described in greater detail below:
a. Process an End User's request to reserve a quantity of gasoline for delivery
b. EU locates nearby or otherwise convenient DSS's at which the EU may take delivery of Gas
c. EU creates and maintain an EU account
d. EU monitors System and Market Conditions.
   i. EU checks Gas Commodity prices
   ii. EU checks the status of EU and DSS inventories
   iii. EU checks servicing times at DSS's
   iv. EU compares System prices with retail pricing
e. EU plans future purchases and deliveries outside
f. EU trades inventories with and/or transfer gas to other System members.
g. System Orders a RBOB Contract.
h. System Orders Transportation Services.
i. System Orders Distribution Services.
j. System Orders Dispensing Services.
k. System Reallocates an Unused Accepted EOS.

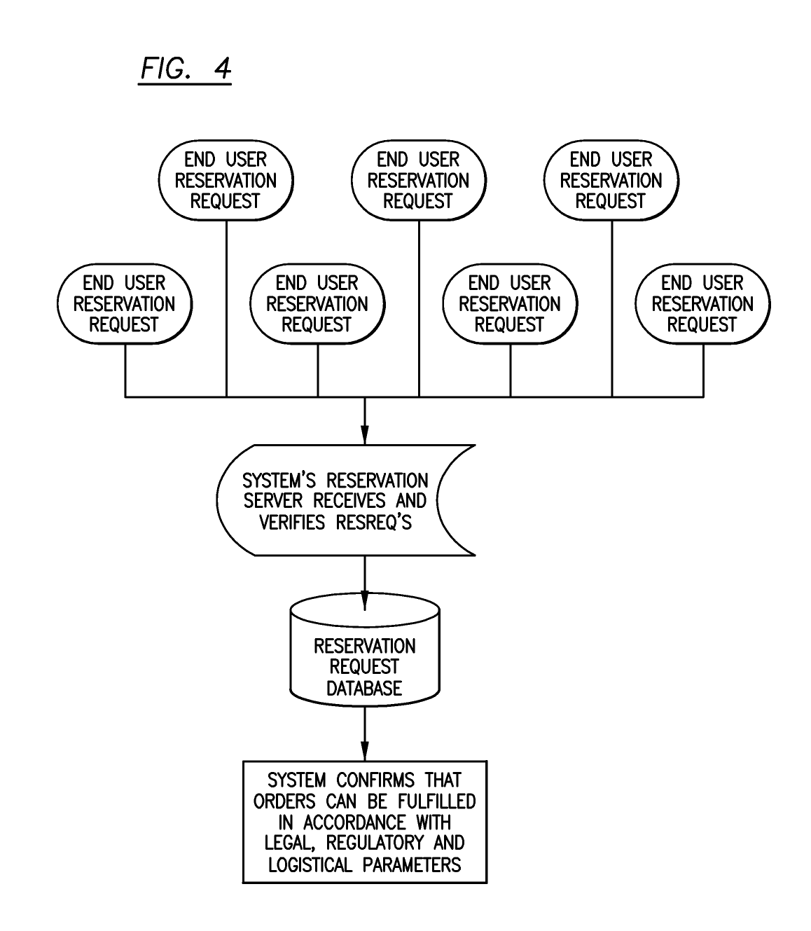

Referring now to FIG. 3, the manner in which the System separates the commodity price component of gasoline purchase from those other components. The System allows an End User to pay: (1) a commodity seller an amount of gasoline (or right to withdraw a gallon of gasoline from ANY gasoline station which participates in or subscribes to the proposed System), (2) a System Administrator a fee for coordinating product refinement, distribution, and storage, as well as for maintaining System accounting and ensuring that the commodity will be readily and efficiently available when the end user wishes to take delivery, and (3) the service station operator at which the end user takes delivery a fee for serving as a point of storage and distribution.

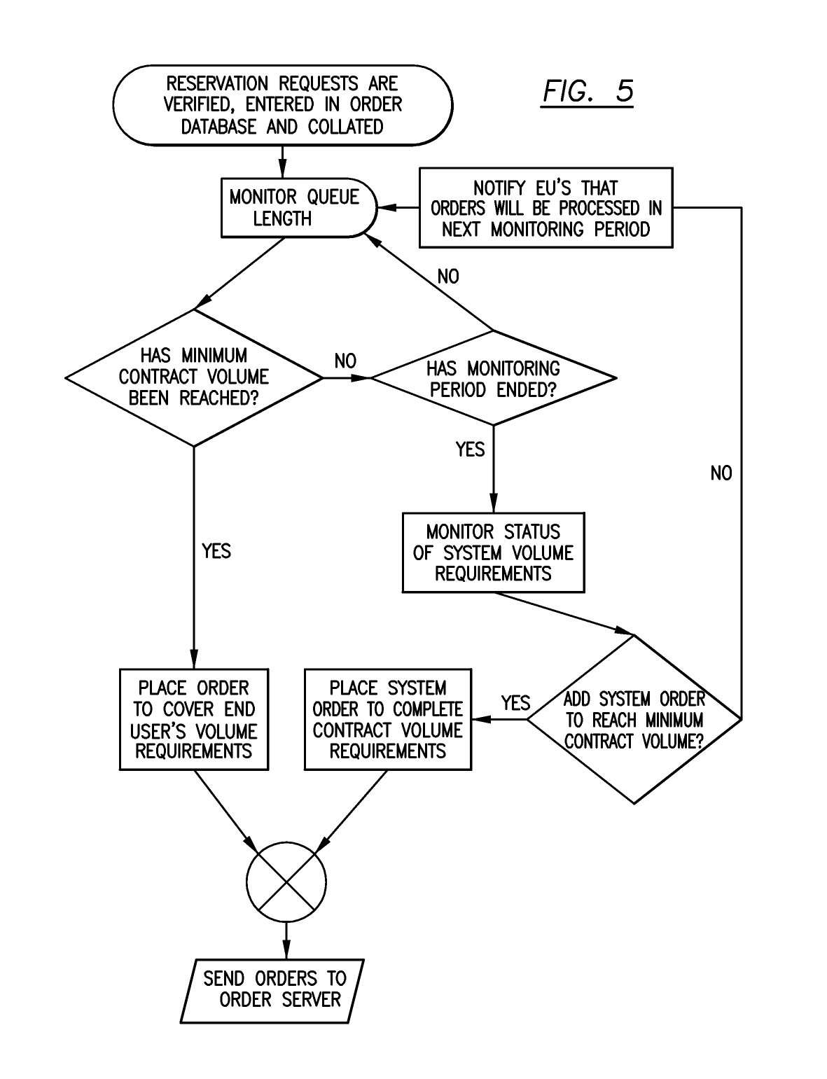

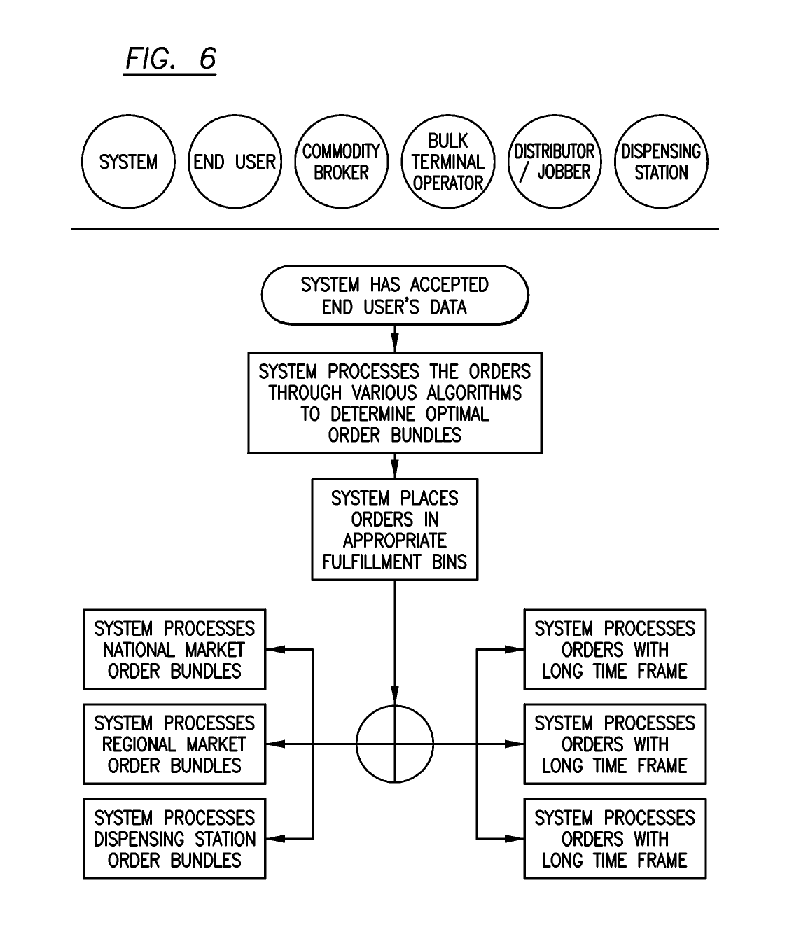

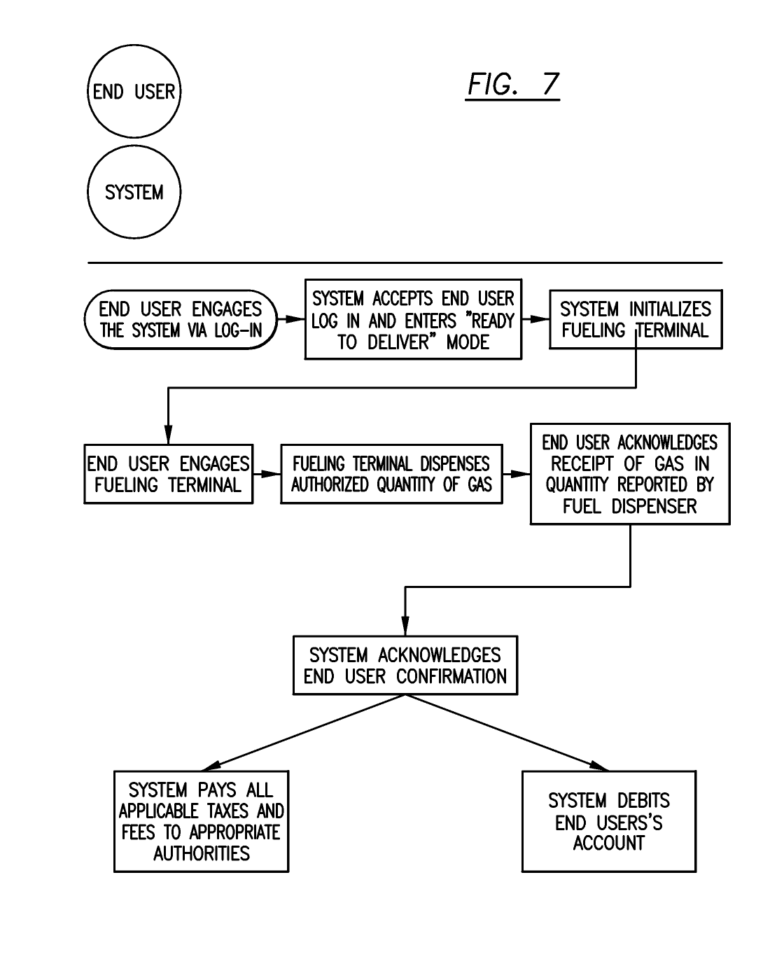

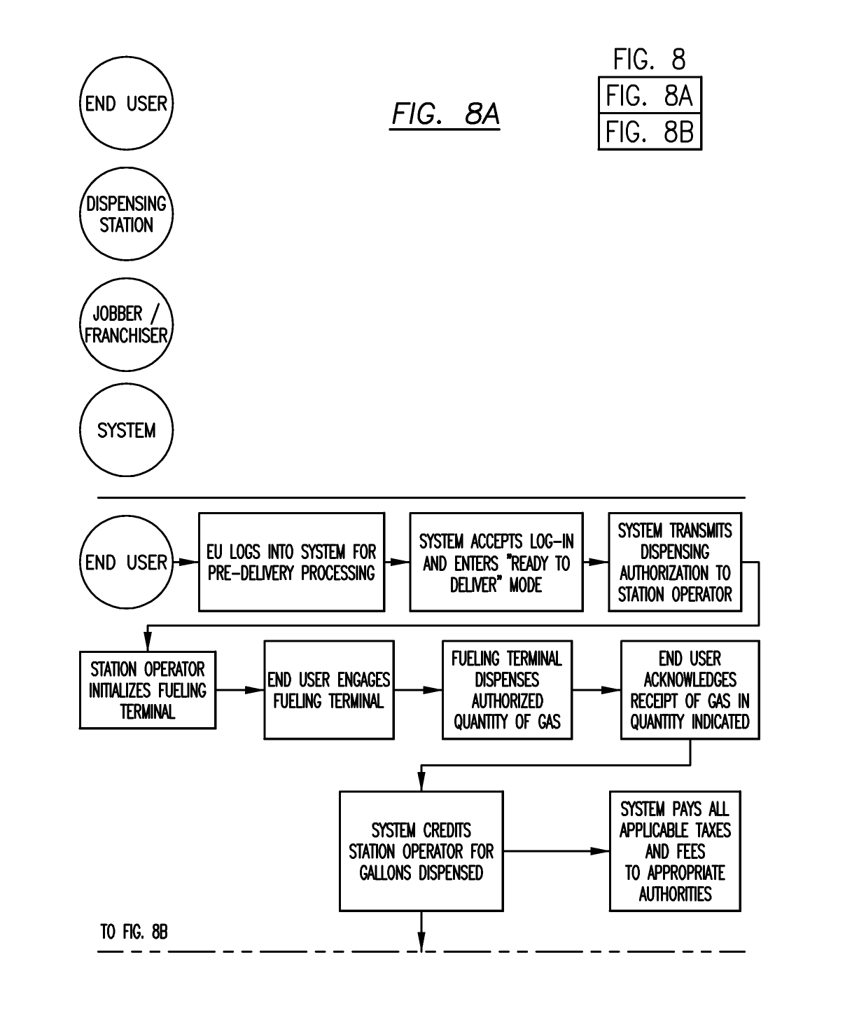

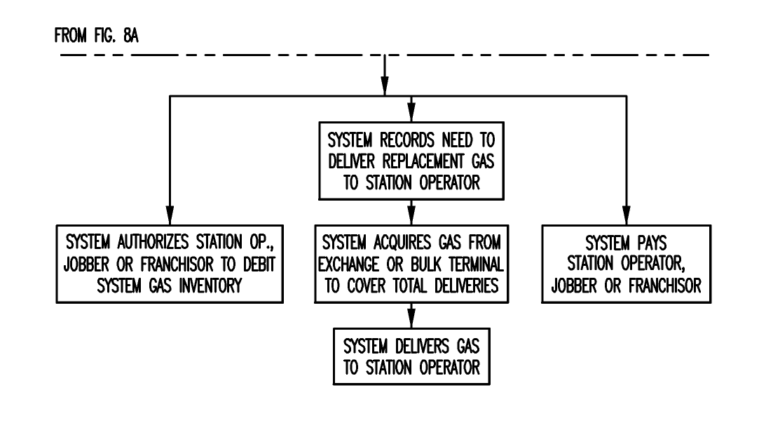

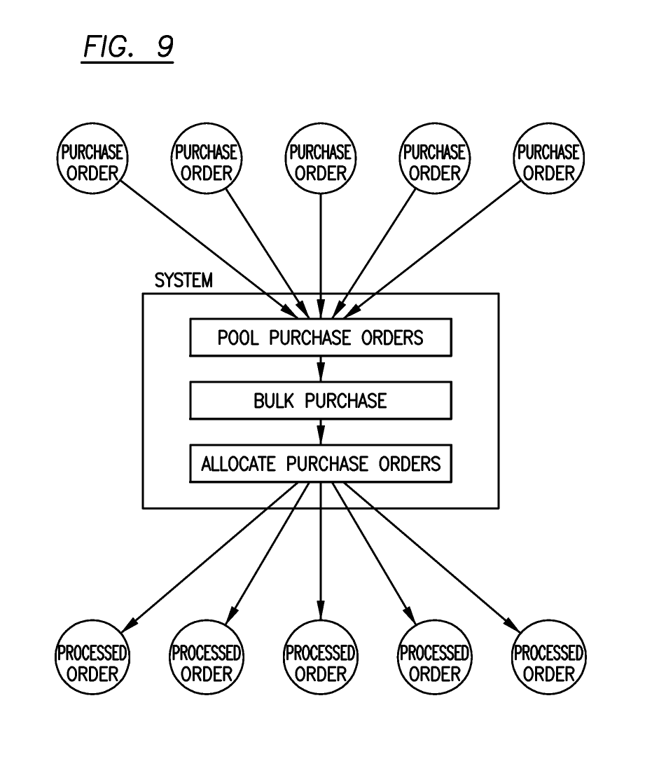

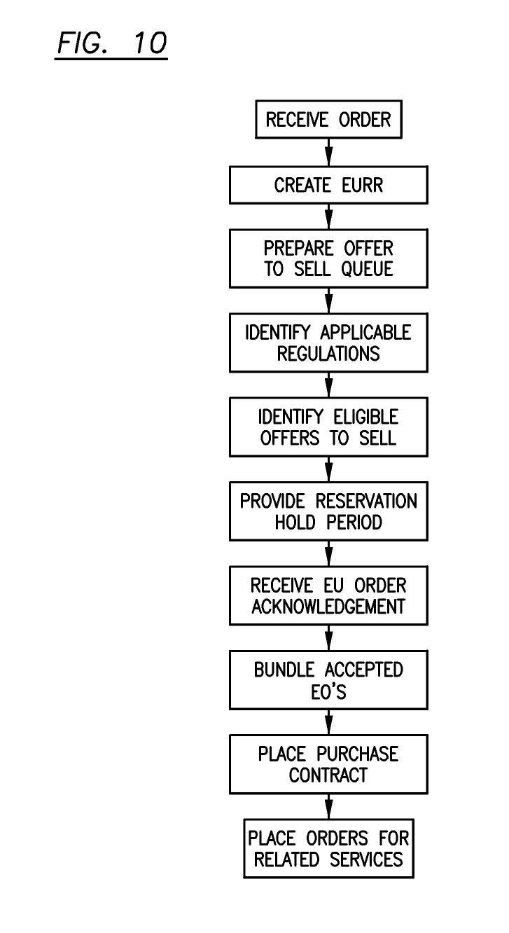

Referring now to FIGS. 4-10, the manner in which the System processes an End User's request to reserve a quantity of gasoline for delivery is shown in further detail. The System's Order receipt and processing, processing of reservation requests with all parameters specified, order fulfillment, system operated dispensing station delivery/settlement, and non-system operated dispensing station delivery/settlement processes are as follows:
i. Place an Order:
   (1) Automated Request per On-Board Vehicle Module.
      (a) The End User populates his or her profile with pre-need parameters detailing the circumstances under which the System will automatically proceed with an order on the End User's behalf. Such circumstances may include:
         (i) a specified schedule; or
         (ii) a signal from a module on-board an End User vehicle indicating that the vehicle's fuel tank has reached a specified level. In order for this module to be effective, the End User will need to equip his vehicle with a device which maintains a communication link with the System. For example, such a device might consist of a Bluetooth enabled addition to the vehicle's fuel gauge which communicates with the System via the End User's cellular telephone. That device might also specify the vehicle's location at the time the signal is sent, thereby allowing the System to locate any nearby Dispensing Stations. The System would, in turn, advise the End User using an SMS or other message regarding the location of the most convenient Dispensing Station at which the End User might take delivery of an energy product.
      (b) When the triggering event occurs (such as when the System receives a message from the on-board device), the System proceeds with a Reservation Request using parameters previously recorded in the End User's profile. (c) Thereafter, the System processes the Reservation Request as specified below.
   (2) Manually entered Reservation Request.
      (a) After logging into the System, the EU allows the System to detect the EU's physical location, and then confirms that location.
      (b) The EU selects the type of transaction the EU would like to complete, namely “Gas Purchase.”
      (c) The EU specifies transaction parameters.
         (i) The System provides the EU with a list of options to specify where the EU is likely to take delivery of the Gas. (“Non-specified DSS” will be an option.)
         (ii) The System provides the EU with a list of options to specify the when the EU is likely to take delivery of Gas. (“Non-Specified Delivery Time” will be an option.)
ii. Using the EU's responses, the System creates an “EU Reservation Request” (or “EURR”).
   (1) The System creates an EURR (which actually consists of a set of EURR's for each part of the transaction) by processing the EU's profile, credit history and location of EU at the time of transaction, as well as any additional variables the EU has specified, such as, location of proposed delivery, time frame for delivery.
   (2) The System classifies the EURR and processes it accordingly.
   (3) The offer might reflect a reservation to take delivery of a specified amount at a specified System DSS at a specified location within a specified time frame, coinciding with unsold and unreserved inventory that the DSS already has on hand. As such, the offer would include a System fee, commodity price, a jobber delivery fee, dispensing fee, and all applicable taxes and other fees.
      (a) The System queries its own inventory to determine whether it has any resources with which to satisfy the EURR.
         (i) If the System has inventory that satisfies the EURR, the System makes an intra-System EPO and reservation.
         (ii) If the System lacks sufficient inventory to satisfy the EURR, the System either initiates the acquisition of additional System resources, or attempts to satisfy the EU's request through another provider.
         (iii) The System queries other DSS's in the relevant market to determine whether they have inventory with which to meet the EU's need.
         (iv) If sufficient resources cannot be immediately identified inside or outside of the System within a specified time frame, the System advises the EU and asks the EU whether the System should continue attempts to fulfill the EU's request over a longer period of time.
      (b) The EURR might also reflect the right to take a specified amount of gas from an unspecified System DSS within a specified delivery area within an unspecified time frame. As such, the offer would include only a System fee, a commodity price and all applicable taxes. The jobber delivery fee, dispensing fee and other fees would be determined at the time of delivery.
      (c) Likewise, the EURR might reflect the right to withdraw a specified volume from any System DSS. As such, the offer only would reflect a System fee and a commodity price. In turn, the System would determine all applicable taxes, the jobber delivery fee, dispensing fee and other fees at the time of delivery, depending upon the location at which the EU takes delivery.
iii. The System prepares a query to identify “Offers to Sell” from gas commodity providers (including System and non-System commodity sources) that might satisfy the EURR. The Offers to Sell may include all levels of the transaction (i.e., commodity, transportation and distribution, and dispensing).
iv. The System uses its Regulatory Module to identify the Regulations which the EURR might implicate.
   (1) The System identifies the State where the commodity transfer will be deemed to have taken place.
   (2) The System identifies the State where the EU will take delivery of the Gas.
   (3) The System identifies the taxes (i.e., jurisdiction and rate) which it must collect in connection with the EU's Gas purchase.
v. The System identifies any existing internal or external “Eligible Offer to Sell” (an “EOS”) which meet might the requirements of the EURR and comply with applicable regulations.
   (1) In this step, the System compares the EURR with existing System resources to classify it as a request (a) to reserve a number of gas units from previously unsold System inventories, (b) to participate in a previously scheduled but incomplete System purchase, or (c) to initiate the scheduling of a new System purchase to be fulfilled using external sources.
vi. During a “Reservation Hold Period,” the System allows the EU an opportunity to review and select the relevant EOS's. Meanwhile, the System allows other EU's to join a queue to take advantage of any EOS which might meet their EURRs. The System will deem as rejected any EOS the EU fails to select affirmatively within the Reservation Hold Period. Then, the EOS is associated with another EURR for another Reservation Hold period.
   (1) Each EOS is associated with a “Reservation Hold Period.”
   (2) Within the designated Reservation Hold Period, the System maintains a tentative reservation with regard to the commodity, as well as any associated delivery and dispensing services. While so doing, the System continues to manage the System's loads to avoid excessive over-booking and to ensure that System capacity will not be exceeded beyond a tolerable limit. Further, it continues serving other EUs' requests for EPO's. Moreover, the System recognizes that the various components of the transaction are sequentially dependent upon each other and keeps the components in balance while waiting for final settlement of EPO's. Therefore, even though a particular EU may not have specified the DSS at which that EU will take delivery of a specified quantity of gas, the System takes into account and manages the possibility that any EPO might yield an “over booked” scenario.
   (3) The System reports each EOS to the EU and waits for the EU's response.
   (4) The System either marks an EOS as accepted or rejected.
      (a) Accepted EOSs are assigned to for further processing with a view toward making an actual reservation.
      (b) Rejected EOSs are associated with the next EURR in the queue, if any.
vii. The System “bundles” or combines the Accepted EOSs with those of other EUs with a view toward arranging a unit order at the appropriate level.
viii. After the System has bundled sufficient Accepted EOSs to satisfy a contract, the System places a purchase contract with a Commodity Broker.
ix. Likewise, the System places orders for transportation, distribution and dispensing services to fulfill the Accepted EOS's.

In an alternate embodiment, the System maintains an inventory on account with a gas station operator, jobber or franchisor.

In another alternate embodiment, the System delivers gasoline to an Operator after the End User has completed the dispensing transaction.

In yet another alternate embodiment, the System, per a pre-existing arrangement, pays a discounted price at the time the End User originally submitted the Reservation Request or at the time the End User takes delivery.

The instant invention has been shown and described herein in what is considered to be the most practical and preferred embodiment. It is recognized, however, that departures may be made from within the scope of the invention and that obvious modifications will occur to a person skilled in the art.

What is claimed is:

1. A system for purchasing and arranging for receipt of automobile fuel on-line comprising:
a means for receiving and fulfilling multiple orders and reservations from a plurality of End Users for various grades and quantities of fuel and allowing those End Users to specify a variety of times and locations for receipt;
a means for aggregating and sorting various End Users' orders into homogeneous lots of sufficient quantity and definition to correspond to quantities and qualities which are traded on a national or international commodity exchange;
a means for maintaining a database of reservations for End Users and Providers so as to minimize system congestion and to maximize system throughput and system utilization;
a means for monitoring the status and costs associated with operating the various facilities involved in a functionally and geographical diverse network which features facilities for commodity refinement, transportation, distribution and consumption; and
a means for balancing inventories in a commodity production, refinement, distribution and consumption network so as to maximize the efficient use of System facilities.
